(19) United States
(12) Patent Application Publication
(10) Pub. No.: US 2014/0280412 A1
(43) Pub. Date: Sep. 18, 2014

(54) SYSTEM, METHOD, AND COMPUTER PROGRAM PRODUCT FOR DETERMINING A RANDOM VALUE

(71) Applicant: NVIDIA CORPORATION, San Clara, CA (US)

(72) Inventor: Robert Anthony Alfieri, Chapel Hill, NC (US)

(73) Assignee: NVIDIA CORPORATION, Santa Clara, CA (US)

(21) Appl. No.: 13/844,400

(22) Filed: Mar. 15, 2013

(51) Int. Cl. G06F 7/58

(52) U.S. Cl. CPC G06F 7/58
USPC 708/250

(57) ABSTRACT

A system, method, and computer program product are provided for determining a random value. In use, a width value is identified. Additionally, a random value is determined, utilizing the width value, wherein determining the random value is capable of being synthesized as a hardware design. Further, the random value is returned.

The present invention relates to hardware designs, and more particularly to determining a random number to be utilized within a hardware design.

### BACKGROUND

Hardware design and verification are important aspects of the hardware creation process. For example, a hardware description language may be used to model and verify circuit designs. However, current techniques for designing hardware have been associated with various limitations.

For example, random numbers within the current hardware design process may be implemented manually by a designer and may not be synthesizable. As a result, these random numbers may be difficult to produce and analyze. There is thus a need for addressing these and/or other issues associated with the prior art.

### SUMMARY

A system, method, and computer program product are provided for determining a random value. In use, a width value is identified. Additionally, a random value is determined, utilizing the width value, wherein determining the random value is capable of being synthesized as a hardware design. Further, the random value is returned.

### BRIEF DESCRIPTION OF THE DRAWINGS

FIG. 1 shows a method for determining a random value, in accordance with one embodiment.

FIG. 2 shows a method for creating a compute construct, utilizing a random number generator (RNG) function, in accordance with another embodiment.

FIG. 3 shows an exemplary hardware design environment, in accordance with one embodiment.

FIG. 4 illustrates an exemplary system in which the various architecture and/or functionality of the various previous embodiments may be implemented.

### DETAILED DESCRIPTION

FIG. 1 shows a method 100 for determining a random value, in accordance with one embodiment. As shown in operation 102, a width value is identified. In one embodiment, the width value may include a numeric value. For example, the width value may include a positive integer value. In another embodiment, the width value may include a value passed as a parameter of a function (e.g., a hardware function, etc.). For example, the width value may include a value passed to a random value generating hardware function (e.g., a value passed with a call to the random value generating hardware function, etc.). In yet another embodiment, the width value may be received from a user. For example, the user may identify the width value as a parameter to a function call. In another embodiment, the width value may be received from a function (e.g., a function calling the random value generating hardware function, etc.).

Additionally, as shown in operation 104, a random value is determined, utilizing the width value, wherein the determination of the random value is capable of being synthesized as a hardware design. In one embodiment, the random value may include a random number with a width equal to the identified width value. For example, the random value may include a random number having a number of bits equal to the identified width value. In another embodiment, the random value may include adata flow. For example, the random value may include a raw leafdata flow with a width equal to the identified width value.

Further, in one embodiment, determining the random value may include generating the random value, utilizing a random number generator (RNG) algorithm. For example, a random number generator algorithm may be used to generate a random number having a width equal to the identified width value. In another embodiment, the random number generator algorithm may generate a random number value utilizing one or more methods (e.g., a multiply-with-carry method, a subtract-with-borrow method, a Mother method, etc.). In yet another embodiment, the random number generator algorithm may include a default algorithm, an algorithm provided by a user, etc. In still another embodiment, the random number generator algorithm may be coded and stored within the random value generating hardware function.

Further still, in one embodiment, the random value generated by the random number generator algorithm may be divided into two or more segments. For example, the random value generated by the random number generator algorithm may be divided into sections of a predetermined size (e.g., 32 bits, etc.). In another embodiment, one or more registers may be allocated to each of the one or more segments. For example, two variables (e.g., state variables, etc.) may be generated and associated with each of the two or more segments. In yet another embodiment, each of the variables may include a register. For example, each of the variables may include a SEED register that may appear during the debugging of a hardware design (e.g., a hardware design that utilizes the random value generating hardware function, etc.). In another example, if the RNG is implemented in hardware (e.g., a BIST, etc.), the SEED register may exist within the hardware as well.

Additionally, in one embodiment, the determination of the random value is capable of being synthesized as a hardware design such that the determination of the random value may be converted into a hardware design. In another embodiment, the determination of the random value may be performed by the hardware design within an emulator, a field-programmable gate array (FPGA), a parallel computing architecture (e.g., CUDA™, etc.), etc. In yet another embodiment, the determination of the random value may be performed within a built-in self-test (BIST) (e.g., a BIST for on-chip memory, etc.). For example, the RNG may be used to generate random patterns for testing an on-chip SRAM, an off-chip DRAM, or any other off-chip 110 path.

Also, as shown in operation 106, the random value is returned. In one embodiment, the random value may be stored (e.g., in a database, in memory, etc.). In yet another embodiment, the random value may be provided to a function (e.g., a function that passed the width value, etc.), to a user, etc.

Additionally, in one embodiment, determining the random value may be performed by a function (e.g., a function that is passed the plurality of data values and the callback function, etc.), utilizing a processor. In another embodiment, the function may include a random value generating hardware function. In yet another embodiment, the random value generating hardware function may be included within a compute construct. For example, the compute construct may include an entity (e.g., a module, etc.), implemented as part of a hardware description language, that receives one or moredata flows as input and creates one or more outputdata flows, based on the one or more inputdata flows.

Further, in one embodiment, the random value generating hardware function may be utilized by another function (e.g., another function that generates random values, etc.). For example, the random value generating hardware function may be utilized by a Rand( ) function that returns a set of values for a hierarchydata flow. In another example, the random value generating hardware function may be utilized by a Randomize( ) function that randomizes adata flow or subflow. In yet another example, the random value generating hardware function may be utilized by a Rand_N( ) function that returns a random integer of a predetermined range. In still another example, the random value generating hardware function may be utilized by a Heads( ) function that returns a random binary value.

Further still, in one embodiment, the random value generating hardware function may be completely synthesizable. For example, a hardware design may be produced that implements the functionality of the random value generating hardware function. In another embodiment, the random value generating hardware function may be synthesized and run on an emulator, implemented on a field-programmable gate array (FPGA) or simulated using a parallel computing architecture (e.g., CUDA™, etc.). In this way, the random value generating hardware function may enable faster and more thorough hardware simulations.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 2 shows a method 200 for creating a compute construct, utilizing a random number generator (RNG) function, in accordance with one embodiment. As an option, the method 200 may be carried out in the context of the functionality of FIG. 1. Of course, however, the method 200 may be implemented in any desired environment. It should also be noted that the aforementioned definitions may apply during the present description.

As shown in operation 202, an identification of a random number generator function is received. In one embodiment, the random number generator function may include a function that outputs one or more random numbers ordata flows in response to one or more inputs. In another embodiment, the identification of the random number generator function may be performed by a user, utilizing a code block. For example, the identified random number generator function may be called within a general purpose code block, where such code block may include hardware design statements mixed with scripting language statements.

Additionally, in one embodiment, the identified random number generator function may be input by the user into a subroutine of a programming language used to draft code associated with the compute construct. In still another embodiment, the random number generator function may be created and stored, and the identification of the random number generator function may include a reference to the stored random number generator function.

Further, in one embodiment, the identified random number generator function may include code that is implemented in during simulation or during synthesis. In another embodiment, the identified random number generator function may be received in association with standard scripting language code. For example, the identified random number generator function may be included within one or more hardware code components that are interspersed with one or more standard scripting language statements (e.g., Perl statements, etc.).

Further still, as shown in operation 204, a compute construct is created, utilizing the identified random number generator function. In one embodiment, the code block provided by the user containing the identification of the random number generator function may be used to create the control construct, such that the compute construct includes the random number generator function. In another embodiment, the compute construct may include an entity (e.g., a module, etc.), implemented as part of a hardware description language, that receives one or moredata flows as input, where eachdata flow may represent a flow of data.

For example, eachdata flow may represent a flow of data through a hardware design. In another embodiment, eachdata flow may include one or more groups of signals. For example, eachdata flow may include one or more groups of signals including implicit flow control signals. In yet another embodiment, eachdata flow may be associated with one or more interfaces. For example, eachdata flow may be associated with one or more interfaces of a hardware design. See, for example, U.S. patent application Ser. No. ______ (Attorney Docket No. NVIDP801/DU-12-0791), filed Mar. 15, 2013, which is hereby incorporated by reference in its entirety, and which describes examples of creating a compute construct.

Also, as shown in operation 206, one or more operations are performed, utilizing the compute construct. In one embodiment, one or more activateddata flows may be received by the compute construct, and one or more outputdata flows may be output from the compute construct. In another embodiment, the random number generator function may include a RandBits( ) function. For example, the RandBits( ) function may include a hardware function that returns an N-bit-wide raw leafdata flow. It may divide the return value into N/32 parts. For each 32-bit section, it may allocate two SEED[01] registers (e.g., using the Add_State command), and these SEED registers may be displayed in the debugger tool (i.e., waveform viewer) during debugging of the compute construct.

Additionally, in one embodiment, the RandBits( ) function may utilizing a random number generator (RNG) algorithm. For example, the algorithm may include a default algorithm or a user-provided algorithm. In this way, the RandBits( ) function may provide a framework for easily registering random number generator algorithms. In another embodiment, the RandBits( ) function may be completely synthesizable. In this way, verification tests may be synthesized and run on emulators, field-programmable gate arrays (FPGAs) and CUDA™-VCS, which may allow for much faster and more thorough simulations.

Further, in one embodiment, calling RandBits($width) may return a random aFlow->Uint($width) value. In another embodiment, Each RandBits( ) function call in a design may allocate two 32-bit seed state variables for each 32 bits (or partial 32 bits) of RandBits( ) returned. For example, RandBits(50) may use 4 32-bit seeds. In another embodiment, these seeds may appear during debugging in a debugger under State registers named RAND0, RAND1, etc. In another embodiment, the first seed allocated in the design may have a reset value of 32′h87654321, the next may have a reset value of that +1, etc. In yet another embodiment, other RNG functions may require a different number of sizes of seeds.

Further still, in one embodiment, a user may specify an initial seed value during simulation (e.g., using a +<design>_rand_seed=<n>plusarg, etc.), which may start the seeds at <n+0, <n+1>, etc. In another embodiment, the seed values may be changed dynamically. Table 1 illustrates an exemplary implementation of a RandBits( ) function that may be included within a compute construct, in accordance with one embodiment. Of course, it should be noted that the exemplary implementation shown in Table 1 is set forth for illustrative purposes only, and thus should not be construed as limiting in any manner.

TABLE 1

| | |
|---|---|
| my $R = RandBits( 20 ); | # returns 20-bit random leaf value |

Also, in one embodiment, the random number generator function may include a Rand( ) function. For example, calling $Flow->Rand( ) may use $Flow as a template and may returns a randomdata flow of the same structure as $Flow. In another embodiment, $Flow may be an active or inactivedata flow. In yet another embodiment, the Rand( ) function may have no side effects on $Flow.

Table 2 illustrates an exemplary implementation of a Rand( ) function that may be included within a compute construct, in accordance with one embodiment. Of course, it should be noted that the exemplary implementation shown in Table 2 is set forth for illustrative purposes only, and thus should not be construed as limiting in any manner.

TABLE 2

| | |
|---|---|
| my $R = $Flow−>Rand( ); | # returns flow structure |

my $R = RandBits( $Flow−>width( ) )−>As( $Flow ); # this is equivalent
to the above call; $Flow can be active or inactive because it's used only as
a template

As shown in Table 2, in one embodiment, calling $Flow->Rand( ) may in turn call RandBits( ) using $Flow->width( ) and may then uses As( ) to convert the raw random bits back to the packet format of $Flow, which may be an arbitrary hierarchy. In this way, a net of random values may be easily obtained for a hierarchydata flow.

Additionally, in one embodiment, the random number generator function may include a Randomize( ) function. Table 3 illustrates an exemplary implementation of a Randomize( ) function that may be included within a compute construct, in accordance with one embodiment. Of course, it should be noted that the exemplary implementation shown in Table 3 is set forth for illustrative purposes only, and thus should not be construed as limiting in any manner.

TABLE 3

| $Flow−>Randomize( ); | # randomize a State or Out flow or |
|---|---|
| | subflow |
| $Flow <== $Flow−>Rand( ); | # this is equivalent to the above call |

As shown in Table 3, calling $Flow->Randomize( ) may randomize the State or Out (sub)flow denoted by $Flow. In one embodiment, calling $Out_Flow->Randomize( ) may be equivalent to calling $Out_Flow $Out_Flow->Rand( ). In another embodiment, $Out_Flow may also be a State register or ram Array( ) indexed assignment.

Further, in one embodiment, the random number generator function may include a Rand_N( ) function. For example, calling Rand_N($N) may return a 32-bit random integer between 0 and $N−1. In one embodiment, the value of $N may not be known until simulation/synthesis time. In another embodiment, in order to make Rand_N( ) synthesizable but not use a divide instruction in HW, RandBits(32) may be used to get a value, which may then be ANDed with the enclosing power of 2 of $N (this may be performed by another hardware function). If the result is greater than or equal to $N, then $N is subtracted from the result.

Table 4 illustrates an exemplary implementation of a Rand_N( ) function that may be included within a compute construct and which avoids a divide/remainder operation, in accordance with one embodiment. Of course, it should be noted that the exemplary implementation shown in Table 4 is set forth for illustrative purposes only, and thus should not be construed as limiting in any manner.

TABLE 4

| | |
|---|---|
| my $R = Rand_N( $N ); | # returns random number between 0 and |

$N−1
(max 32 bits)
# the implementation below is equivalent to the above call
my $Enclosing_Pow2_m1 = (enclosing pow2 that can hold $N) − 1; #
uses $N−>Count_Leading_Zeros( ) in 5 logic levels

| | |
|---|---|
| my $Bits32 = RandBits( 32 ) & $Enclosing_Pow2_m1; | # chop off |

high-order bits

| | |
|---|---|
| my $R = ($Bits32 >= $N) ? ($Bits32 − $N) : $Bits32; | # make sure |

we stay in 0 .. $N−1

As shown in Table 4, calling Rand_N($N) may return a random 32-bit integer between 0 and $N−1. In one embodiment, $N may be a dynamic hardware value. In another embodiment, if $N is a power of two (e.g., 16, etc.), Rand_N($N) may return 0 . . . 15, etc. In yet another embodiment, if $N is a constant, then Rand_N($N) may return a value with a bitwidth required to hold $N−1. In another embodiment, If N is a power of 2, then Rand_N( ) may use RandBits(log2(N)). In still another embodiment, Rand_N( ) may be used to pick a subtest to run based on certain probabilities that add up to 100. For example, to get an even distribution, N may be given a value of 128, and the probabilities may be scaled so they add up to 128. In this way, Rand_N( ) may know that N is a power-of-2 at build time and may use RandBits(7).

Further still, in one embodiment, the random number generator function may include a Heads( ) function. For example, calling the Heads( ) function may be equivalent to calling. Rand_N(2) or RandBits(1) and may return a value of 0 or 1. Table 5 illustrates an exemplary implementation of a Heads( ) function that may be included within a compute construct, in accordance with one embodiment. Of course, it should be noted that the exemplary implementation shown in Table 5 is set forth for illustrative purposes only, and thus should not be construed as limiting in any manner.

TABLE 5

| | |
|---|---|
| my $R = Heads( ); | # returns random 0 or 1 |
| my $R = RandBits( 1 ); | # this is equivalent to the above call |
| my $R = Rand_N( 2 ); | # this is equivalent to the above call |

Also, in one embodiment, the compute construct may be incorporated into the integrated circuit design in association with the one or moredata flows. In one embodiment, the one or moredata flows may be passed into the compute construct, where they may be checked at each stage. In another embodiment, errors may be immediately found and the design script may be killed immediately upon finding an error. In this way, a user may avoid reviewing a large amount of propagated errors. In yet another embodiment, the compute construct may check that each inputdata flow is an outputdata flow from some other construct or is what is called a deferred output.

Forex a deferred output may include an indication that adata flow is a primary design input or adata flow will be connected later to the output of some future construct. In another embodiment, it may be confirmed that each inputdata flow is an input to no other constructs. In yet another embodiment, each construct may create one or more outputdata flows that may then become the inputs to other constructs. In this way, the concept of correctness-by-construction may be promoted. In still another embodiment, the constructs may be superflow-aware. For example, some constructs may expect superflows, and others may perform an implicit ‘for’ loop on the superflow's subflows so that the user doesn't have to.

Furthermore, in one embodiment, a set of introspection methods may be provided that may allow user designs and generators to interrogatedata flows. For example, the compute construct may use these introspection functions to perform their work. More specifically, the introspection methods may enable obtaining a list of field names within a hierarchicaldata flow, widths of various subflows, etc. In another embodiment, in response to the introspection methods, values may be returned in forms that are easy to manipulate by the scripting language.

Further still, in one embodiment, the compute construct may include constructs that are built in to the hardware description language and that perform various data steering and storage operations that have to be built into the language. In another embodiment, the constructs may be bug-free (verified) as an incentive for the user to utilize them as much as possible.

Also, in one embodiment, the compute construct may contain one or more parameters. For example, the compute construct may contain a “name” parameter that indicates a base module name that will be used for the compute construct and which shows up in the debugger. In another embodiment, the compute construct may contain a “comment” parameter that provides a textual comment that shows up in the debugger. In yet another embodiment, the compute construct may contain a parameter that corresponds to an interface protocol. In one embodiment, the interface protocol may include a communications protocol associated with a particular interface.

In another embodiment, the communications protocol may include one or more formats for communicating data utilizing the interface, one or more rules for communicating data utilizing the interface, a syntax used when communicating data utilizing the interface, semantics used when communicating data utilizing the interface, synchronization methods used when communicating data utilizing the interface, etc. In one example, the compute construct may include a parameter that corresponds to an interface protocol. In one embodiment, the interface protocol may include a communications protocol associated with a particular interface. In another embodiment, the communications protocol may include one or more formats for communicating data utilizing the interface, one or more rules for communicating data utilizing the interface, a syntax used when communicating data utilizing the interface, semantics used when communicating data utilizing the interface, synchronization methods used when communicating data utilizing the interface, etc. In one example, the compute construct may include a “stallable” parameter that indicates whether automaticdata flow control is to be performed within the construct (e.g., whether inputdata flows are to be automatically stalled when outputs aren't ready, etc.). For example, if the “stallable” parameter is 0, the user may use variousdata flow methods such as Valid( ) and Ready( ), as well as a Stall statement to perform manual flow control.

Additionally, in one embodiment, the compute construct may contain an out_fifo parameter that allows the user to specify a depth of the output FIFO for each outputdata flow. For example, when multiple outputdata flows are present, the user may supply one depth that is used by all, or an array of per-output-flow depths. In another embodiment, the compute construct may contain an out_reg parameter that causes the outputdata flow to be registered out. For example, the out_reg parameter may take a 0 or 1 value or an array of such like out_fifo.

Further, in one embodiment, the compute construct may contain an out_rdy_reg parameter that causes the outputdata flow's implicit ready signal to be registered in. This may also lay down an implicit skid flip-flop before the out_reg if the latter is present. In another embodiment, out_fifo, out_reg, and out_rdy_reg may be mutually exclusive and may be used in any combination.

Further still, in one embodiment, clocking and clock gating may be handled implicitly by the compute construct. For example, there may be three levels of clock gating that may be generated automatically: fine-grain clock gating (FGCG), second-level module clock gating (SLCG), and block-level design clock gating (BLCG). In another embodiment, FGCG may be handled by synthesis tools. In yet another embodiment, a per-construct (i.e., per-module) status may be maintained. In still another embodiment, when the status is IDLE or STALLED, all the flip-flops and rams in that module may be gated. In another embodiment, the statuses from all the constructs may be combined to form the design-level status that is used for the BLCG. This may be performed automatically, though the user may override the status value for any Compute( ) construct using the Status <value> statement.

Also, in one embodiment, a control construct may be incorporated into the integrated circuit design in association with the compute construct and the one or moredata flows. For example, an outputdata flow from the control construct may act as inputdata flow to the compute construct, or an outputdata flow from the compute construct may act as an inputdata flow to the control construct. See, for example, U.S. patent application Ser. No. ______ (Attorney Docket No. NVIDP800/DU-12-0790), filed Mar. 15, 2013, which is hereby incorporated by reference in its entirety, and which describes exemplary compute constructs.

FIG. 3 shows an exemplary hardware design environment 300, in accordance with one embodiment. As an option, the environment 300 may be carried out in the context of the functionality of FIGS. 1-2. Of course, however, the environment 300 may be implemented in any desired environment. It should also be noted that the aforementioned definitions may apply during the present description.

As shown, within a design module 302, reusable component generators 304, functions 306, and a hardware description language embedded in a scripting language 308 are all used to construct a design that is run and stored 310 at a source database 312. Also, any build errors within the design are corrected 344, and the design module 302 is updated. Additionally, the system backend is run on the constructed design 314 as the design is transferred from the source database 312 to a hardware model database 316.

Additionally, the design in the hardware model database 316 is translated into C++ or CUDA™ 324, translated into Verilog® 326, or sent directly to the hardware model database 336. If the design is translated into C++ or CUDA™ 324, the translated design 330 is provided to a signal dump 334 and then to a high level debugger 336. If the design is translated into Verilog® 326, the translated design is provided to the signal dump 334 or a VCS simulation 328 is run on the translated design, which is then provided to the signal dump 334 and then to the high level GUI (graphical user interface) waveform debugger 336. Any logic bugs found using the high level GUI waveform debugger 336 can then be corrected 340 utilizing the design module 302.

FIG. 4 illustrates an exemplary system 400 in which the various architecture and/or functionality of the various previous embodiments may be implemented. As shown, a system 400 is provided including at least one host processor 401 which is connected to a communication bus 402. The communication bus 402 may be implemented using any suitable protocol, such as PCI (Peripheral Component Interconnect), PCI-Express, AGP (Accelerated Graphics Port), HyperTransport, or any other bus or point-to-point communication protocol(s). The system 400 also includes a main memory 404. Control logic (software) and data are stored in the main memory 404 which may take the form of random access memory (RAM).

The system 400 also includes input devices 412, a graphics processor 406 and a display 408, i.e. a conventional CRT (cathode ray tube), LCD (liquid crystal display), LED (light emitting diode), plasma display or the like. User input may be received from the input devices 412, e.g., keyboard, mouse, touchpad, microphone, and the like. In one embodiment, the graphics processor 406 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user. The system may also be realized by reconfigurable logic which may include (but is not restricted to) field programmable gate arrays (FPGAs).

The system 400 may also include a secondary storage 410. The secondary storage 410 includes, for example, a hard disk drive and/or a removable storage drive, representing a floppy disk drive, a magnetic tape drive, a compact disk drive, digital versatile disk (DVD) drive, recording device, universal serial bus (USB) flash memory, etc. The removable storage drive reads from and/or writes to a removable storage unit in a well-known manner.

Computer programs, or computer control logic algorithms, may be stored in the main memory 404 and/or the secondary storage 410. Such computer programs, when executed, enable the system 400 to perform various functions. Memory 404, storage 410 and/or any other storage are possible examples of computer-readable media.

In one embodiment, the architecture and/or functionality of the various previous figures may be implemented in the context of the host processor 401, graphics processor 406, an integrated circuit (not shown) that is capable of at least a portion of the capabilities of both the host processor 401 and the graphics processor 406, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 400 may take the form of a desktop computer, laptop computer, server, workstation, game consoles, embedded system, and/or any other type of logic. Still yet, the system 400 may take the form of various other devices m including, but not limited to a personal digital assistant (PDA) device, a mobile phone device, a television, etc.

Further, while not shown, the system 400 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
identifying a width value;
determining a random value, utilizing the width value, wherein determining the random value is capable of being synthesized as a hardware design; and
returning the random value.

2. The method of claim 1, wherein the width value includes a positive integer value.

3. The method of claim 1, wherein the random value includes a random number with a width equal to the identified width value.

4. The method of claim 1, wherein determining the random value includes generating the random value, utilizing a random number generator (RNG) algorithm.

5. The method of claim 4, wherein the random number generator algorithm includes a default algorithm.

6. The method of claim 4, wherein the random number generator algorithm includes an algorithm provided by a user.

7. The method of claim 4, wherein the random value generated by the random number generator algorithm is divided into two or more segments.

8. The method of claim 4, wherein the random value generated by the random number generator algorithm is divided into sections of a predetermined size.

9. The method of claim 7, wherein one or more registers are allocated to each of the one or more segments.

10. The method of claim 7, wherein two registers are generated and associated with each of the two or more segments.

11. The method of claim 10, wherein each of the registers include a SEED register that is displayed by a waveform viewer during a debugging of a hardware design that utilizes the random value generating hardware function.

12. The method of claim 1, wherein determining the random value is performed by a random value generating hardware function, utilizing a processor.

13. The method of claim 12, wherein the random value generating hardware function is included within a compute construct.

14. The method of claim 12, wherein the random value generating hardware function is utilized by a Rand( ) function that returns a set of values for a hierarchydata flow.

15. The method of claim 12, wherein the random value generating hardware function is utilized by a Randomize( ) function that randomizes adata flow or subflow.

16. The method of claim 12, wherein the random value generating hardware function is utilized by a Rand_N( ) function that returns a random integer of a predetermined length.

17. The method of claim 16, wherein the Rand_N( ) function avoids a divide/remainder operation.

18. The method of claim 12, wherein the random value generating hardware function is utilized by a Heads( ) function that returns a random binary value.

19. A computer program product embodied on a computer readable medium, comprising:
code for identifying a width value;
code for determining a random value, utilizing the width value, wherein the code for determining the random value is capable of being synthesized as a hardware design; and
code for returning the random value.

20. A system, comprising:
a processor for identifying a width value; determining a random value, utilizing the width value, and returning the random value, wherein determining the random value is capable of being synthesized as a hardware design.
